(19) United States
(12) Patent Application Publication
(10) Pub. No.: US 2026/0177656 A1
(43) Pub. Date: Jun. 25, 2026

(54) COOPERATIVE POSITIONING METHOD FOR INTELLIGENT VEHICLES IN UNKNOWN ENVIRONMENTS

(71) Applicant: SOUTHEAST UNIVERSITY, Jiangsu (CN)

(72) Inventors: Xu LI, Jiangsu (CN); Yue HU, Jiangsu (CN); Qimin XU, Jiangsu (CN)

(73) Assignee: SOUTHEAST UNIVERSITY, Jiangsu (CN)

(21) Appl. No.: 19/538,987

(22) Filed: Feb. 13, 2026

Related U.S. Application Data
(63) Continuation of application No. PCT/CN2023/118670, filed on Sep. 14, 2023.

(30) Foreign Application Priority Data
Aug. 14, 2023 (CN) 202311022307.7

(51) Int. Cl. G01S 5/14

(52) U.S. Cl. CPC G01S 5/14

(57) ABSTRACT

A cooperative positioning method for intelligent vehicles in unknown environments includes: first, constructing a cooperative positioning system; second, constructing a cooperative positioning observation model; then, training the cooperative positioning observation model for predicting a position increment of an intelligent vehicle; and finally, constructing a cooperative fusion positioning model to acquire a position of the intelligent vehicle. The cooperative positioning method for intelligent vehicles in unknown environments disclosed in the present disclosure achieves cooperative positioning of intelligent vehicles in unknown environments having missing prior information and limited observation information.

### CROSS-REFERENCE TO RELATED APPLICATION

This application is a continuation of International Application No. PCT/CN2023/118670, filed on Sep. 14, 2023, which claims priority to Chinese patent application No. 202311022307.7, titled “UNKNOWN ENVIRONMENT-ORIENTED INTELLIGENT VEHICLE COLLABORATIVE POSITIONING METHOD” and filed with the China National Intellectual Property Administration on Aug. 14, 2023. The above applications are hereby incorporated by reference in their entireties.

### TECHNICAL FIELD

The present disclosure belongs to the field of cooperative positioning of intelligent vehicles, and particularly relates to a cooperative positioning method for intelligent vehicles in unknown environments.

### BACKGROUND

In recent years, thanks to advancements in deep learning, sensors, information processing and other technologies, intelligent vehicles have developed rapidly and been gradually applied in fields such as intelligent transport and emergency rescue. Acquiring accurate position information is a fundamental guarantee for performing subsequent operations. Although providing accurate position information in most cases, the Global Navigation Satellite System (GNSS) fails in semi-occluded or fully-occluded environments such as urban canyons, tree-lined roads, and tunnels. cooperative positioning based on ultra-wideband, cellular, Bluetooth, and other wireless sensor networks (WSN) is a solution when satellites fail. Generally, a cooperative positioning system consists of a receiving station and a base station. For an intelligent vehicle, a receiving station is usually fixed on the intelligent vehicle, and a base station is usually fixed on a roadside. cooperative positioning is performed to measure a distance or angle between a wireless sensor and an intelligent vehicle, and then a triangulation positioning method is used to obtain a position of the intelligent vehicle.

Therefore, a cooperative positioning method in the prior art usually requires position information of roadside base stations, and four or more base stations are needed to calculate three-dimensional position information of an intelligent vehicle. However, prior position information of roadside base stations is missing in many cases, that is, an unknown environment exists. In such an environment, an intelligent vehicle system does not know prior position information of a roadside base station, such that a traditional triangulation positioning method does not apply; and additionally, continuous deployment of a plurality of roadside base stations incurs additional costs, and the requirement of at least four roadside base stations to achieve three-dimensional positioning limits an application of cooperative positioning to a certain extent. Therefore, cooperative positioning in the prior art has the following defects: (1) failure to achieve cooperative positioning when prior position information of roadside base stations is missing; (2) and failure to achieve three-dimensional cooperative positioning of an intelligent vehicle when there are less than four roadside base stations. Therefore, cooperative positioning of an intelligent vehicle still remains challenging in the above unknown environment.

### SUMMARY

The present disclosure provides a cooperative positioning method for intelligent vehicles in unknown environments, and the method has the following specific characteristics: (1) Prior position information of a roadside base station is not required. The method provided in the present disclosure enables to achieve positioning only by using distance observation information provided by the roadside base station without need of knowing position information of the roadside base station; and (2) observation information from only one roadside base station is needed to achieve three-dimensional positioning of an intelligent vehicle. The method provided in the present disclosure does not require observation information from at least four roadside base stations, but the distance observation information from only one roadside base station is needed to achieve positioning.

The method of the present disclosure includes: first, constructing a cooperative positioning system; second, constructing a cooperative positioning observation model; then, training the model for predicting a position increment of an intelligent vehicle; and finally, constructing a cooperative fusion positioning model to acquire a position of the intelligent vehicle.

An idea of the present disclosure is further explained as follows:

### Step 1: Constructing a Cooperative Positioning System

The cooperative positioning system in the present disclosure mainly includes an intelligent vehicle and a roadside base station, the intelligent vehicle is equipped with an inertial navigation system (INS), and velocity information of the intelligent vehicle is obtained by the system through integral operation. Additionally, a wireless receiving device configured to receive information of distance between the intelligent vehicle and the roadside base station is fixed to the intelligent vehicle, and wireless transmitting device configured to measure and provide distance information is fixed to the roadside base station.

### Step 2: Constructing a Cooperative Positioning Observation Model

### Sub-Step 1: Constructing a Model Input

Given that a position change of the intelligent vehicle is mainly caused by changes in its own velocity, attitude angle, or the like, and the position change of the intelligent vehicle is reflected in a distance change measured by the roadside base station, therefore, a mathematical model for estimating the position change of the intelligent vehicle is established in the present disclosure. The model inputs changes of the intelligent vehicle in the velocity, attitude angle, and distance change between the intelligent vehicle and the roadside base station per unit time, and outputs the position change of the intelligent vehicle per unit time.

Further, to better decouple the position changes in each direction, multi-layer perceptron (MLP) models for predicting the position changes in eastward, northward, and upward (vertical) directions are separately constructed in the present disclosure. An eastward position change prediction model inputs an eastward velocity change Δvₓ, a heading angle change Δh, and a distance change Δd, and outputs an eastward position change Δx, a northward position change prediction model inputs a northward velocity change Δv_{y}, the heading angle change Δh, and the distance change Δd, and outputs a northward position change Δy, and an upward position change prediction model inputs an upward velocity change Δv_{z}, a pitch angle change Δp, and the distance change Δd, and outputs an upward position change Δz.

### Sub-Step 2: Constructing a Model Network Structure

Given that changes in the velocity, attitude angle, and the like are time-series data, a Long Short-Term Memory (LSTM) network is first used to process the time-series data. In the present disclosure, the input for each model includes the velocity change, the attitude angle change, and the distance change, and a temporal length of an input sequence is 10, that is, an input layer dimension is 30, the number of LSTM layers is set to 1, and the number of hidden nodes is 64. Then, a fully connected layer is used to continue regressing a position increment, and an output of the LSTM serves as an input of the fully connected layer. In the present disclosure, there are two fully connected layers, each of the two fully connected layers has 11 nodes, and a final output layer dimension is 1, i.e., a predicted position increment.

### Step 3: Collecting Data to Train the Model

Data of the cooperative positioning system are collected, mainly including the eastward velocity change, the northward velocity change, the upward velocity change, and the attitude angle change of the intelligent vehicle per unit time, as well as the change of distance between the intelligent vehicle and the base station. The velocity change and the attitude angle change of the intelligent vehicle may be provided by the INS, on condition that an initial absolute position and absolute attitude angle of the intelligent vehicle are known, and the distance change is provided by the roadside base station. After data collection, the model constructed in the above steps is trained, a loss function is a mean square error (MSE), and the training is terminated when the number of training epochs reaches a preset threshold or the error is less than a preset threshold.

### Step 4: Using the Trained Model to Obtain Cooperative Observations

During the actual operation of the intelligent vehicle, the velocity change and the attitude angle change of the intelligent vehicle, the distance change obtained from the roadside base station, and the like, are input into the above trained model to predict three-dimensional position changes Δx, Δy, Δz of the intelligent vehicle. Then, cooperative observation information of the intelligent vehicle's position is finally obtained based on position information of the intelligent vehicle at a previous moment.

$$\{ \begin{matrix}{x}_{k} = {x}_{k - 1} + Δ x \\ {y}_{k} = {y}_{k - 1} + Δ y \\ {z}_{k} = {z}_{k - 1} + Δ z\end{matrix} \qquad ( 2 )$$

In the above formula, the subscript represents time. Finally, the cooperative observation information of the intelligent vehicle's position is obtained when a position of the roadside base station is unknown and there is only one base station.

### Step 5: Constructing a Cooperative Fusion Positioning Model

A cooperative fusion positioning model based on Kalman filtering is constructed to fuse the cooperative positioning observation information obtained in the above steps and the information provided by the INS of the intelligent vehicle. The information provided by the INS is used for time update, and the cooperative positioning observation information is used for measurement update. For the fusion model based on Kalman filtering, refer to the reference (Qin Yongyuan, Zhang Hongyue, and Wang Shuhua. Kalman Filter and Integrated Navigation [M]. Northwestern Polytechnical University Press, 2012).

The present disclosure has the beneficial effects as follows: the cooperative positioning method for intelligent vehicles in unknown environments provided by the present disclosure achieves the cooperative positioning of the intelligent vehicle in an unknown environment where the position information of the roadside base station is unknown and the observation information is insufficient, and effectively promotes the further development of cooperative positioning technology.

### BRIEF DESCRIPTION OF THE DRAWINGS

FIG. 1 is a flowchart of a method of the present disclosure.

FIG. 2 is a schematic diagram of a cooperative positioning observation model.

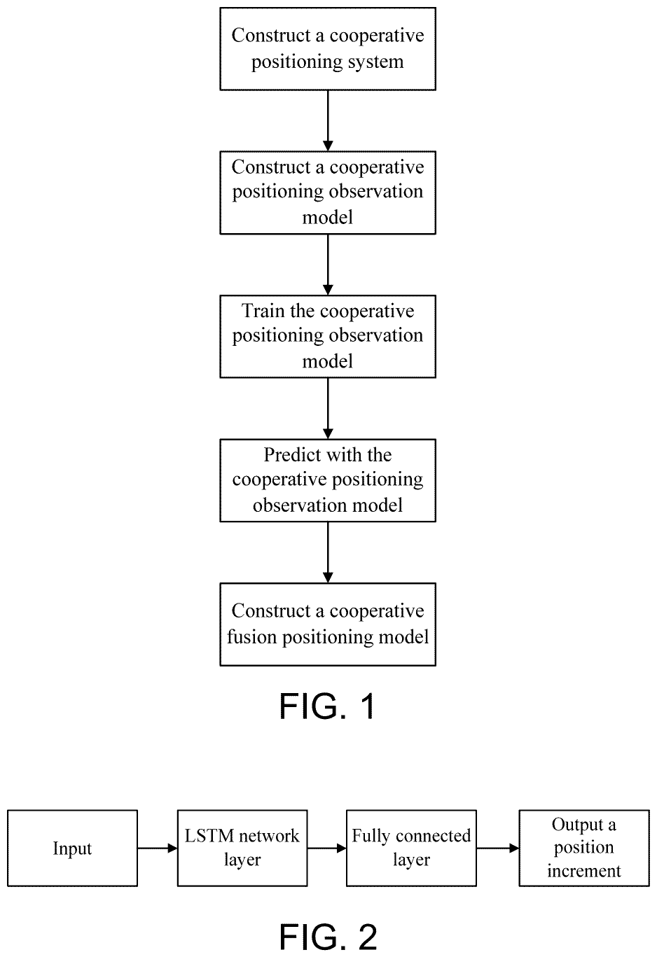

### DESCRIPTIONS OF EMBODIMENTS

In recent years, thanks to advancements in deep learning, sensors, information processing and other technologies, intelligent vehicles have developed rapidly and been gradually applied in fields such as intelligent transport and emergency rescue. Acquiring accurate position information is a fundamental guarantee for performing subsequent operations. Although providing accurate position information in most cases, the Global Navigation Satellite System (GNSS) fails in semi-occluded or fully-occluded environments such as urban canyons, tree-lined roads, and tunnels. cooperative positioning based on ultra-wideband, cellular, Bluetooth, and other wireless sensor networks (WSN) is a solution when satellites fail. Generally, a cooperative positioning system consists of a receiving station and a base station. For an intelligent vehicle, a receiving station is usually fixed on the intelligent vehicle, and a base station is usually fixed on a roadside. cooperative positioning is performed to measure a distance or angle between a wireless sensor and an intelligent vehicle, and then a triangulation positioning method is used to obtain a position of the intelligent vehicle.

Therefore, a cooperative positioning method in the prior art usually requires position information of roadside base stations, and four or more base stations are needed to calculate three-dimensional position information of an intelligent vehicle. However, prior position information of roadside base stations is missing in many cases, that is, an unknown environment exists. In such an environment, an intelligent vehicle system does not know prior position information of a roadside base station, such that a traditional triangulation positioning method does not apply; and additionally, continuous deployment of a plurality of roadside base stations incurs additional costs, and the requirement of at least four roadside base stations to achieve three-dimensional positioning limits an application of cooperative positioning to a certain extent. Therefore, cooperative positioning in the prior art has the following defects: (1) failure to achieve cooperative positioning when prior position information of roadside base stations is missing; (2) and failure to achieve three-dimensional cooperative positioning of an intelligent vehicle when there are less than four roadside base stations. Therefore, cooperative positioning of an intelligent vehicle still remains challenging in the above unknown environment.

To solve the above problems, the present disclosure provides a cooperative positioning method for intelligent vehicles in unknown environments, and the method has the following specific characteristics: (1) Prior position information of roadside base stations is not required. The method provided in the present disclosure enables to achieve positioning only by using distance observation information provided by the roadside base station without need of knowing position information of the roadside base station; and (2) observation information from only one roadside base station is needed to achieve three-dimensional positioning of an intelligent vehicle. The method provided in the present disclosure does not require observation information from at least four roadside base stations, but the distance observation information from only one roadside base station is needed to achieve positioning.

The cooperative positioning method for intelligent vehicles in unknown environments provided by the present disclosure achieves the cooperative positioning of the intelligent vehicle in an unknown environment where the position information of the roadside base station is unknown and the observation information is insufficient, and effectively promotes the further development of cooperative positioning technology.

An idea of the present disclosure is further explained as follows:

### Step 1: Construct a Cooperative Positioning System

The cooperative positioning system in the present disclosure mainly includes an intelligent vehicle and a roadside base station, the intelligent vehicle is equipped with an inertial navigation system (INS), and velocity information of the intelligent vehicle is obtained by the system through integral operation. Additionally, a wireless receiving device configured to receive information of distance between the intelligent vehicle and the roadside base station is fixed to the intelligent vehicle, and wireless transmitting device configured to measure and provide distance information is fixed to the roadside base station.

### Step 2: Construct a Cooperative Positioning Observation Model

### Sub-Step 1: Construct a Model Input

Given that a position change of the intelligent vehicle is mainly caused by changes in its own velocity, attitude angle, or the like, and the position change of the intelligent vehicle is reflected in a distance change measured by the roadside base station, therefore, a mathematical model for estimating the position change of the intelligent vehicle is established in the present disclosure. The model inputs changes of the intelligent vehicle in the velocity, attitude angle, and distance change between the intelligent vehicle and the roadside base station per unit time, and outputs the position change of the intelligent vehicle per unit time.

Further, to better decouple the position changes in each direction, multi-layer perceptron (MLP) models for predicting the position changes in eastward, northward, and upward (vertical) directions are separately constructed in the present disclosure. An eastward position change prediction model inputs an eastward velocity change Δvₓ, a heading angle change Δh, and a distance change Δd, and outputs an eastward position change Δx, a northward position change prediction model inputs a northward velocity change Δv_{y}, the heading angle change Δh, and the distance change Δd, and outputs a northward position change Δy, and an upward position change prediction model inputs an upward velocity change Δv_{z}, a pitch angle change Δp, and the distance change Δd, and outputs an upward position change Δz.

### Sub-Step 2: Construct a Model Network Structure

Given that changes in the velocity, attitude angle, and the like are time-series data, a Long Short-Term Memory (LSTM) network is first used to process the time-series data. In the present disclosure, the input for each model includes the velocity change, the attitude angle change, and the distance change, and a time length of an input sequence is 10, that is, an input layer dimension is 30, the number of LSTM layers is set to 1, and the number of hidden nodes is 64. Then, a fully connected layer is used to continue regressing a position increment, and an output of the LSTM serves as an input of the fully connected layer. In the present disclosure, there are two fully connected layers, each of the two fully connected layers has 11 nodes, and a final output layer dimension is 1, i.e., a predicted position increment.

### Step 3: Collect Data to Train the Model

Data of the cooperative positioning system are collected, mainly including the eastward velocity change, the northward velocity change, the upward velocity change, and the attitude angle change of the intelligent vehicle per unit time, as well as the distance change between the intelligent vehicle and the base station. The velocity change and the attitude angle change of the intelligent vehicle may be provided by the INS, on condition that an initial absolute position and absolute attitude angle of the intelligent vehicle are known, and the distance change is provided by the roadside base station. After data collection, the model constructed in the above steps is trained, a loss function is a mean square error (MSE), and the training is terminated when the number of training epochs reaches a preset threshold or the error is less than a preset threshold.

Step 4: use the trained model to obtain cooperative observations

During the actual operation of the intelligent vehicle, the velocity change and the attitude angle change of the intelligent vehicle, the distance change obtained from the roadside base station, and the like, are input into the above trained model to predict three-dimensional position changes Δx, Δy, Δz of the intelligent vehicle. Then, cooperative observation information of the intelligent vehicle's position is finally obtained based on position information of the intelligent vehicle at a previous moment.

$$\{ \begin{matrix}{x}_{k} = {x}_{k - 1} + Δ x \\ {y}_{k} = {y}_{k - 1} + Δ y \\ {z}_{k} = {z}_{k - 1} + Δ z\end{matrix} \qquad ( 3 )$$

In the above formula, the subscript represents time. Finally, the cooperative observation information of the intelligent vehicle's position is obtained when a position of the roadside base station is unknown and there is only one base station.

### Step 5: Construct a Cooperative Fusion Positioning Model

A cooperative fusion positioning model based on Kalman filtering is constructed to fuse the cooperative positioning observation information obtained in the above steps and the information provided by the INS of the intelligent vehicle. The information provided by the INS is used for time update, and the cooperative positioning observation information is used for measurement update. For the fusion model based on Kalman filtering, refer to the reference (Qin Yongyuan, Zhang Hongyue, and Wang Shuhua. Kalman Filter and Integrated Navigation [M]. Northwestern Polytechnical University Press, 2012).

What is claimed is:

1. A cooperative positioning method for intelligent vehicles in unknown environments, comprising: first, constructing a cooperative positioning system; second, constructing a cooperative positioning observation model; then, training a model for predicting a position increment of an intelligent vehicle; and finally, constructing a cooperative fusion positioning model to acquire a position of the intelligent vehicle, wherein specific steps comprise:
step 1: constructing the cooperative positioning system
the cooperative positioning system comprises the intelligent vehicle and a roadside base station, wherein, the intelligent vehicle is equipped with an inertial navigation system, and velocity information of the intelligent vehicle is obtained by a system through integral operation; additionally, a wireless receiving device configured to receive information of distance between the intelligent vehicle and the roadside base station is fixed to the intelligent vehicle, and a wireless transmitting device configured to measure and provide distance information is fixed to the roadside base station;
step 2: constructing a cooperative positioning observation model
sub-step 1: constructing a model input
given that position changes of the intelligent vehicle is caused by changes in its own velocity, attitude angle, or the like, and the position changes of the intelligent vehicle are reflected in a distance changes measured by the roadside base station, therefore, a mathematical model for estimating the position changes of the intelligent vehicle is established; the model inputs a velocity change and an attitude angle change of the intelligent vehicle, and a distance change between the intelligent vehicle and the roadside base station per unit time, and outputs the position changes of the intelligent vehicle per unit time;
to better decouple the position changes in each direction, multi-layer perceptron (MLP) models are separately constructed for predicting the position changes in eastward, northward, and upward (vertical) directions; an eastward position change prediction model inputs an eastward velocity change Δvₓ, a heading angle change Δh, and a distance change Δd, and outputs an eastward position change Δx, a northward position change prediction model inputs a northward velocity change Δv_{y}, the heading angle change Δh, and the distance change Δd, and outputs a northward position change Δy, and an upward position change prediction model inputs an upward velocity change Δv_{z}, a pitch angle change Δp, and the distance change Δd, and outputs an upward position change Δz;
sub-step 2: constructing a model network structure
given that the velocity change and the attitude angle change are time-series data, a Long Short-Term Memory (LSTM) network is first used to process the time-series data; in the present disclosure, the input for each model comprises the velocity change, the attitude angle change, and the distance change, and a temporal length of an input sequence is 10, that is, an input layer dimension is 30, the number of LSTM layers is set to 1, and a number of hidden nodes is 64; then, a fully connected layer is used to continue regressing a position increment, and an output of the LSTM serves as an input of the fully connected layer; there are two fully connected layers, each of the two fully connected layers has 11 nodes, and a final output layer dimension is 1, i.e., a predicted position increment;
step 3: collecting data to train the model
data of the cooperative positioning system are collected, comprising the eastward velocity change, the northward velocity change, the upward velocity change, and the attitude angle change of the intelligent vehicle per unit time, as well as the distance change between the intelligent vehicle and the base station, wherein the velocity change and the attitude angle change of the intelligent vehicle are provided by an inertial navigation system (INS), on condition that an initial absolute position and absolute attitude angle of the intelligent vehicle are known, and the distance change is provided by the roadside base station; after data collection, the model constructed in the above steps is trained, a loss function is a mean square error (MSE), and the training is terminated when a number of training epochs reaches a preset threshold or the error is less than a preset threshold;
step 4: using a trained model to obtain cooperative observations
during actual operation of the intelligent vehicle, the velocity change and the attitude angle change of the intelligent vehicle, the distance change obtained from the roadside base station, and the like, are input into the above trained model to predict three-dimensional position changes Δx, Δy, Δz of the intelligent vehicle; then, cooperative observation information of the intelligent vehicle's position is finally obtained based on position information of the intelligent vehicle at a previous moment;
$$\{ \begin{matrix}{x}_{k} = {x}_{k - 1} + Δ x \\ {y}_{k} = {y}_{k - 1} + Δ y \\ {z}_{k} = {z}_{k - 1} + Δ z\end{matrix} \qquad ( 1 )$$
in the above formula, a subscript represents time, and finally, the cooperative observation information of the intelligent vehicle's position is obtained when a position of the roadside base station is unknown and there is only one base station; and
step 5: constructing a cooperative fusion positioning model
a cooperative fusion positioning model based on Kalman filtering is constructed to fuse the cooperative observation information obtained in the above steps and the information provided by the INS of the intelligent vehicle, wherein the information provided by the INS is used for time update, and the cooperative observation information is used for measurement update.
